(19) United States
(12) Patent Application Publication
(10) Pub. No.: US 2007/0028102 A1
(43) Pub. Date: Feb. 1, 2007

(54) System for processing data and method thereof

(75) Inventor: Josephus Arnoldus Henricus Maria Kahlman, EINDHOVEN (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/571,170

(22) PCT Filed: Aug. 31, 2004
(86) PCT No.: PCT/IB04/51613

§ 371 Date: Mar. 9, 2006

(30) Foreign Application Priority Data
Sep. 15, 2003 (EP) 03103390.5

(51) Int. Cl. H04L 9/00

(52) U.S. Cl. 713/168

(57) ABSTRACT

Record carrier identification information is stored using an asymmetry modulation (FIGS. 1,2,3). This prevents the access to this information throught the regular data path (65) of the playback device (60). The asymmetry information is automatically removed by the playback device because of the inherent data slicing FIG. 4) and decoding that takes place in the play back device.

The invention relates to a record carrier comprising a group of channel bits recorded in a track where the group of channel bits comprises record carrier identification information,a method for recording a record identification information on a record carrier comprising a group of channel bits recorded in a track where the group of channel bits comprises record carrier identification information, a method for retrieving a record identification information from a record carrier comprising a group of channel bits recorded in a track where the group of channel bits comprises record carrier identification information, a method for copy right control of information stored on a record carrier where the record carrier comprises a record carrier comprising a group of channel bits recorded in a track of the record carrier where the group of channel bits comprises record carrier identification information, a playback device for optical discs comprising an addressing means and a data retrieval means, and a recording device for record carriers comprising an addressing means and a data recording means.

Such a record carrier is known in the form of CD and DVD record carriers where the manufacturer provides an entry on the record carrier that allows a playback device to determine who manufactured the record carrier.

Furthermore this is also known from recordable and rewriteable record carriers where a copy right notice is recorded on the record carrier.

Furthermore such record carriers are known from PC games where the manufacturer introduces defects on the master of the record carrier to allow playback devices to identify the record carrier by verifying whether all defects are at the expected locations.

The drawback of these record carriers is that the record carrier identification information is readily available to anybody with access to the record carrier.

It is an objective of the invention to provide a record carrier with identification information that is not readily available to anybody with access to the record carrier.

To achieve this objective the record carrier is characterized in the record carrier identification information is stored in the group of channel bits with an asymmetry modulation.

Because the asymmetry of a group of channel bits is not readily accessible via a playback device the record carrier identification information modulated in the asymmetry of the group of channel bits is hidden and non-accessible, even if anybody has access to the record carrier. The playback device comprises a data slicer in the data retrieval path which removes any asymmetry, thus preventing access to the asymmetry information.

A further embodiment is characterized in that the asymmetry modulation is a pit width modulation.

A wider pit exhibits a lower reflection, effectively locally disturbing the DC level, thus introducing an asymmetry of a group of channel bits. One or more of these 10 disturbances of the DC level of the channel bits can be used to represent, via a modulation, the record carrier identification information.

Information about the amount of reflection is removed by the data slicer before the data is being processed by the playback device. Access to information about the DC content, and thus to the amount of reflection is not possible without special arrangements in the playback device.

A further embodiment is characterized in that the asymmetry modulation is a running digital sum modulation.

The channel code normally strives to provide a running digital sum of the code words as close to zero as possible. Control over the running digital sum can for instance be achieved by using replacement code words where at given instances in the stream of code words a code word can be replaced by another unique code word that results in a lower running digital sum if this is advantageous for the running digital sum. If the replacement code word results in a higher running digital sum the code word is not replaced by the replacement code word. To store record carrier identification information on the record carrier this scheme can be altered by replacing the code word by the replacement code word if that is would result in a higher running digital sum. This deviation from the expected scheme is thus used to modulate the record carrier information and is effectively an asymmetry modulation because the code words locally exhibit a higher DC content than expected.

A further embodiment is characterized in that the asymmetry modulation is a channel bit transition position modulation.

By repositioning the transitions of the channel bits the DC content can be modulated and asymmetry achieved. Because the subsequent PLL realigns the transitions with the extracted clock the data stream is not affected while a low frequency content near DC can be introduced in the spectrum of the HF stream of channel bits.

A further embodiment is characterized in that the channel bits are encoded using a parity preserving code.

Using a parity preserving code allows a very tight control of the DC content and thus of the asymmetry of the channel bits. Any deviation from this tightly asymmetry of the channel bits can thus more easily be detected by the playback device comprising a asymmetry detector device.

A further embodiment is characterized in that the record carrier identification information is stored in a predetermined position.

Storing the record carrier identification information in a predetermined position allows the playback device to quickly retrieve the asymmetry of the channel bits in that location and determine the stored record carrier identification information without having to search parts or the entire record carrier for a group of channel bits with an asymmetry modulation.

A further embodiment is characterized in that a pointer to the predetermined position is stored on the record carrier.

In order to prevent the information to be stored in the same position on each and every record carrier a pointer is stored on each record carrier, either encrypted, i.e. in a well protected form, or unprotected.

When the record carrier comprises a pointer the playback device can find the record carrier identification information of every record carrier quickly.

A further embodiment is characterized in that the record carrier comprises a PIC band and that the location of the predetermined position is stored in the PIC band. The PIC band is defined by the blu-disc standard and is suitable to store the pointer in encrypted or unprotected form.

A method for recording a record identification information on a record carrier according to the invention comprises the step of:
modulating the record carrier identification information in the group of channel bits with an asymmetry modulation;
storing the group of channel bits with an asymmetry modulation on the record carrier.

By executing this method a record carrier is created that allows the retrieval of the record carrier identification information from the record carrier by a player while preventing exact duplication of the record carrier by placing the identification information on the record carrier in such a way that a direct extraction through the normal data path of the playback device is not possible.

An embodiment of the method for recording a record carrier identification information is characterized in that the step of modulating the record carrier identification information in the group of channel bits with an asymmetry modulation comprises the step of modulating a running digital sum of the channel bits.

By inserting the modualtion in the running digital sum the record carrier identification infomration is only accessible to the playback device internally and not through the normal data path of the playback device, preventing the extraction of the identification information by a regular user.

Control over the running digital sum can for instance be achieved by using replacement code words where at given instances in the stream of code words a code word can be replaced by another unique code word that results in a. lower running digital sum if this is advantageous for the running digital sum. If the replacement code word results in a higher running digital sum the code word is not replaced by the replacement code word. To store record carrier identification information on the record carrier this scheme can be altered by replacing the code word by the replacement code word if that is would result in a higher running digital sum. This deviation from the expected scheme is thus used to modulate the record carrier information and is effectively an asymmetry modulation because the code words locally exhibit a higher DC content than expected.

Alternatively the watermark is applied according to a spread-spectrum technique.

The key required for the detection is encoded into the disc, preferably in encrypted form.

Another alternative is the introduction of a the watermark in the form of an analogue signal e.g. a sine wave, or a modulated sine wave (AM, FM, PM etc.).

When using the channel bit transition modulation the detection is carried out by observing the transition positions with respect to the detection moments achieved by using a PLL and data slicer with a faster threshold determination. In this embodiment the watermark bandwidth can be higher.

A further embodiment of the method for recording a record carrier identification information is characterized in that the channel bits are encoded using a parity preserving code.

Using a parity preserving code allows a very tight control of the DC content and thus of the asymmetry of the channel bits. Any deviation from this tightly asymmetry of the channel bits can thus more easily be detected by the playback device comprising a asymmetry detector device.

A further embodiment of the method for recording a record carrier identification information is characterized in that the step of storing the group of channel bits with an assymetry modulation on the record carrier comprises the storing of the record carrier identification information in a predetermined position.

Storing the record carrier identification information in a predetermined position allows the playback device later on to quickly retrieve the asymmetry of the channel bits in that location and determine the stored record carrier identification information without having to search parts or the entire record carrier for a group of channel bits with an asymmetry modulation.

A further embodiment of the method for recording a record carrier identification information is characterized in that the method comprises the step of storing a pointer to the predetermined position on the record carrier.

In order to prevent the information to be stored in the same position on each and every record carrier a pointer is stored on each record carrier, either encrypted, i.e. in a well protected form, or unprotected.

When the record carrier comprises a pointer the playback device can find the record carrier identification information of every record carrier quickly.

A further embodiment of the method for recording a record carrier identification information is characterized in that the record carrier comprises a PIC band and that the pointer of the predetermined position is stored in the PIC band.

The PIC band is defined by the blu-disc standard and is suitable to store the pointer in encrypted or unprotected form.

A method for retrieving a record identification information from a record carrier according to the invention comprises the step of:
retrieving a group of channel bits with an asymmetry modulation from the record carrier;
demodulating the record carrier identification information from the retrieved group of channel bits with an asymmetry modulation.

The asymmetry modulation prevents the user to access the record carrier identification information through the normal data path since there are no provisions in a playback device for this.

Because of the data slicer used in the playback device the asymmetry modulation is removed before the data is extracted from the code words.

If alternatively the asymmetry modulation is achieved during coding into code words the removal of the asymmetry modulation is performed during the retrieval of the data from the code words.

Yet easy retrieval and verification of the record carrier identification information can be achieved in the playback device by providing demodulation means that are located before the data slicer or before the decoding of the code words so that the asymmetry demodulation means is provided with the signal retrieved from the record carrier where the signal still contains the asymmetry modulation.

An embodiment of the method for retrieving a record carrier identification information is characterized in that the step of demodulating the record carrier identification information from the group of channel bits with an asymmetry modulation comprises the step of demodulating a running digital sum of the channel bits.

The retrieval of the asymmetry modulation can also be achieved after the data slicer when the asymmetry modualtion has been achived by coding. After the data slicer the replacement code words as used for the control of the DC content are still present and at during the decoding of these code words the information stored using the asymmetry modulation becomes available. Whenever a code word is encountered that is either a replacement code word or a code word that could potentially be replaced by a replacement code word the actual decision to replace or to not replace can be compared to the, for DC control, expected optimum decision. Deviations from the optimum decision form the basis of the asymmetry modulation and demodulation can thus be achieved.

A further embodiment of the method for retrieving a record carrier identification information is characterized in that the step of retrieving the group of channel bits with an asymmetry modulation from the record carrier comprises the retrieving of the record carrier identification information from a predetermined position.

The speed and retrieval of the record carrier identification information is increased while the complexity of the retrieval is reduced since the address of the record carrier identification information is known.

A further embodiment of the method for retrieving a record carrier identification information is characterized in that the method comprises the step of retrieving a pointer to the predetermined position from the record carrier and that the channel bits with an asymmetry modulation are retrieved from the predetermined position indicated by the pointer.

In order to be able to vary the position of the record carrier identification information from record carrier to record carrier, from production run to production run or from manufacturer to manufacturer a pointer can be provided. The pointer tells the playback device the exact location, or a region on the record carrier where the record carrier identification information can be found. The search for the record carrier identification information is thus reduced in time and complexity while at the same time allowing flexibility during the creation of the record carrier.

A further embodiment of the method for retrieving a record carrier identification information is characterized in that the record carrier comprises a PIC band and that the pointer of the predetermined position is retrieved from the PIC band. The PIC band is defined by the blu-disc standard and is suitable to store the pointer in encrypted or unprotected form.

A method for copy right control of information stored on a record carrier where the record carrier comprises a record carrier comprising a group of channel bits recorded in a track of the record carrier where the group of channel bits comprises record carrier identification information, comprising the step of:
retrieving a group of channel bits with an asymmetry modulation from the record carrier;
demodulating the record carrier identification information from the retrieved group of channel bits with an asymmetry modulation;
processing the record carrier identification information to establish a copy right status of the record carrier.

The asymmetry modulation prevents the user to access the record carrier identification information through the normal data path since there are no provisions in a playback device for accessing asymmetry modulated data.

Because of the data slicer used in the playback device the asymmetry modulation is removed before the data is extracted from the code words.

If alternatively the asymmetry modulation is achieved during coding into code words the removal of the asymmetry modulation is performed during the retrieval of the data from the code words.

Yet easy retrieval and verification of the record carrier identification information can be achieved in the playback device by providing demodulation means that are located before the data slicer or before the decoding of the code words so that the asymmetry demodulation means is provided with the signal retrieved from the record carrier where the signal still contains the asymmetry modulation.

After retrieving the record carrier identification information the playback device can determine the copy right status of the material on the record carrier. If the copy right indicates that the material on the record carrier may be duplicated the recorder can release the material for instance by indicating to a recording device that it is allowed to record the material as provided by the playback device.

If the copy right indicates that the material, or portions thereof, on the record carrier may not be duplicated the playback device can refuse request fro the material from a recording device or indicate to the recording device that duplication is illegal. The mechanisms to prevent illegal duplication can be located ire either the playback device or the recorder.

Alternatively the record carrier identification information can be used to prevent any playback of illegal record carriers. Those illegal record carriers will not have the proper record carrier identification information because the record carrier identification information is lost during the duplication as outlined above. The playback device will refuse the access to the material on the record carrier whenever the proper record carrier identification information is missing or incorrect.

A further embodiment of the method for copy right control of information stored on a record carrier is characterized in that the step of retrieving the group of channel bits with an asymmetry modulation from the record carrier comprises the retrieving of the record carrier identification information from a predetermined position By retrieving the record carrier identification information from a predetermined position the retrieval is quicker compared to the retrieval from a random position.

A further embodiment of the method for copy right control of information stored on a record carrier is characterized in that the method comprises the step of retrieving a pointer to the predetermined position from the record carrier and that the channel bits with an asymmetry modulation are retrieved from the predetermined position indicated by the pointer.

By first retrieving a pointer before retrieving the record carrier identification information the location of the record carrier indentification information can be varied from record carrier to record carrier, from production run to production run, from manufacturer to manufacturer, or from recorder to recorder. This prevents the easy circumvention of the copy right control.

A further embodiment of the method for copy right control of information stored on a record carrier is characterized in that the record carrier comprises a PIC band and that the pointer of the predetermined position is retrieved from the PIC band.

By storing the point er in the PIC band the recorder can easily access the information togetehr with other disc related information.

A playback device for optical discs comprising an addressing means and a data retrieval means accoridng to the invention is characterized in that the playback device further comprises a DC content retrieval means that is arranged for retrieving a record carrier identification information from a record carrier by demodulating an asymmetry of a group of channel bits retrieved from the record carrier from an address indicated by the addressing means.

An embodiment of the playback device is characterized in that the playback device further comprises a copy right control device that is arranged for retrieving a addressing means are arranged to process the record carrier identification information to establish a copy right status of the record carrier the address from a location on the record carrier and where the addressing means is arranged to retrieve a pointer to a location from the record carrier and to indicate the location to the DC content retrieval means.

A further embodiment of the playback device is characterized in that the recording device further comprises a asymmetry modulation device that is arranged for storing a record carrier identification information on a record carrier by modulating an asymmetry of a group of channel bits, where the asymmetry modulation device is coupled to the data recording means which is arranged for recording the group of channel bits provided by the asymmetry modulation device on an location on the record carrier indicated by the addressing means.

The invention will now be discussed based on figures.

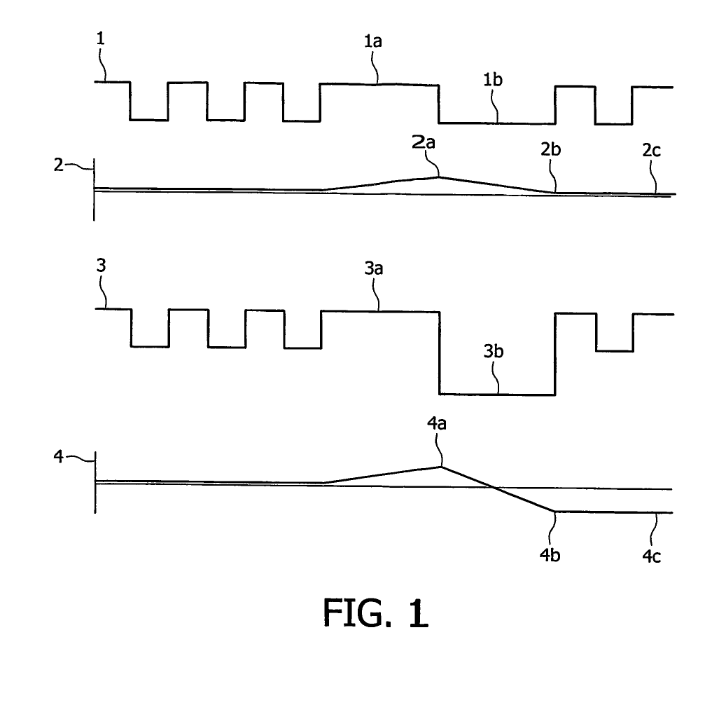

FIG. 1 shows asymmetry of channel bits through pit width modulation

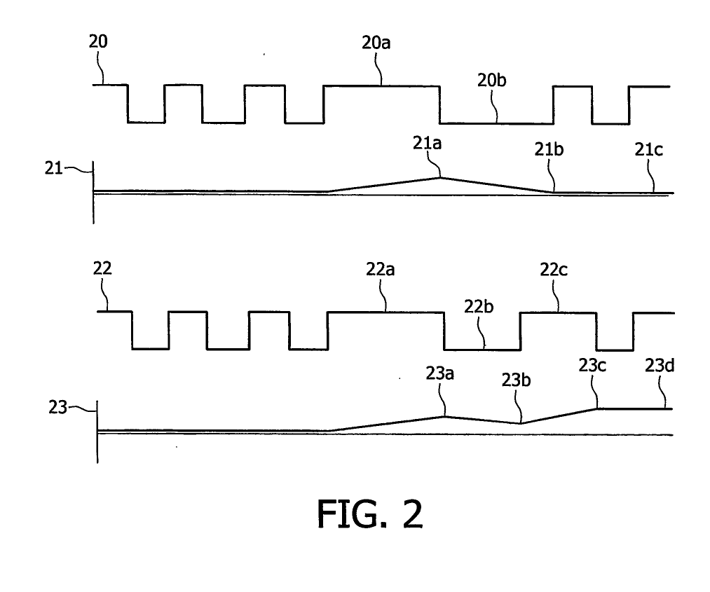

FIG. 2 shows asymmetry of channel bits through coding

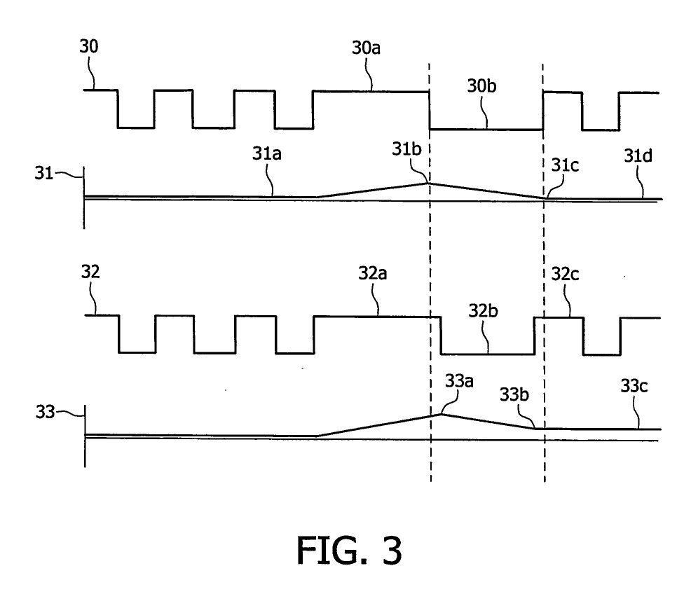

FIG. 3 shows asymmetry of channel bits through transition modulation.

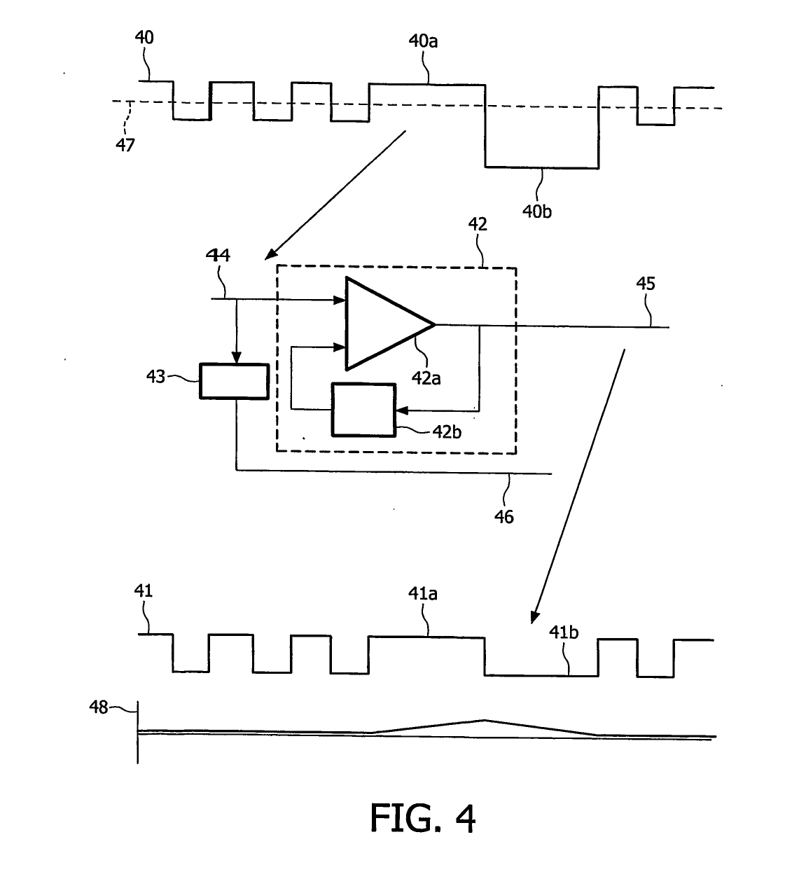

FIG. 4 shows the effect of a data slicer on the asymmetry

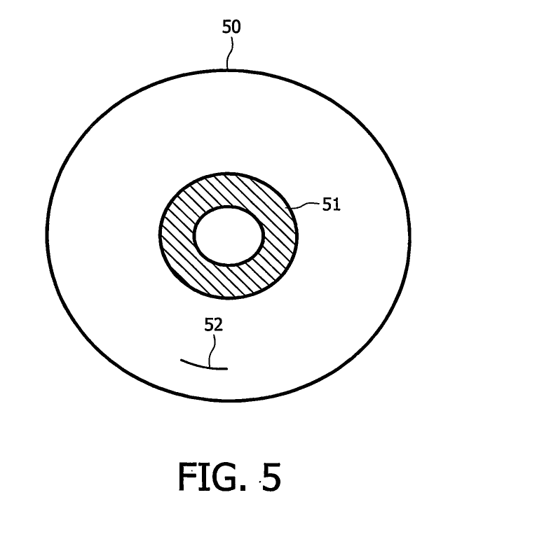

FIG. 5 shows a record carrier with asymmetry

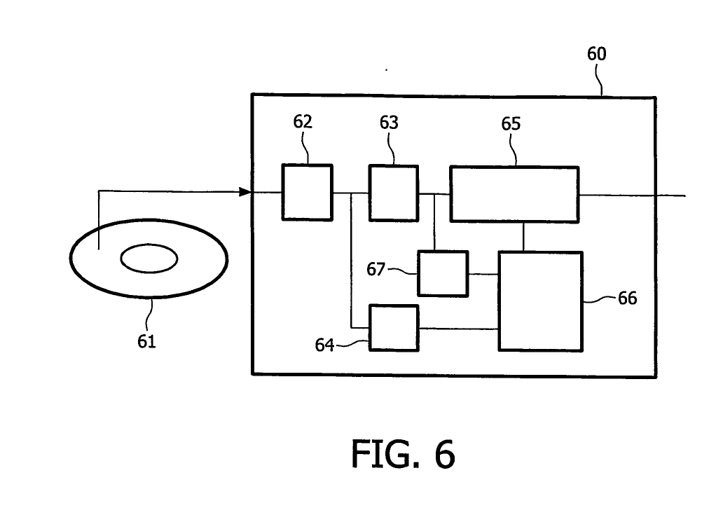

FIG. 6 shows a playback device comprising the asymmetry detector

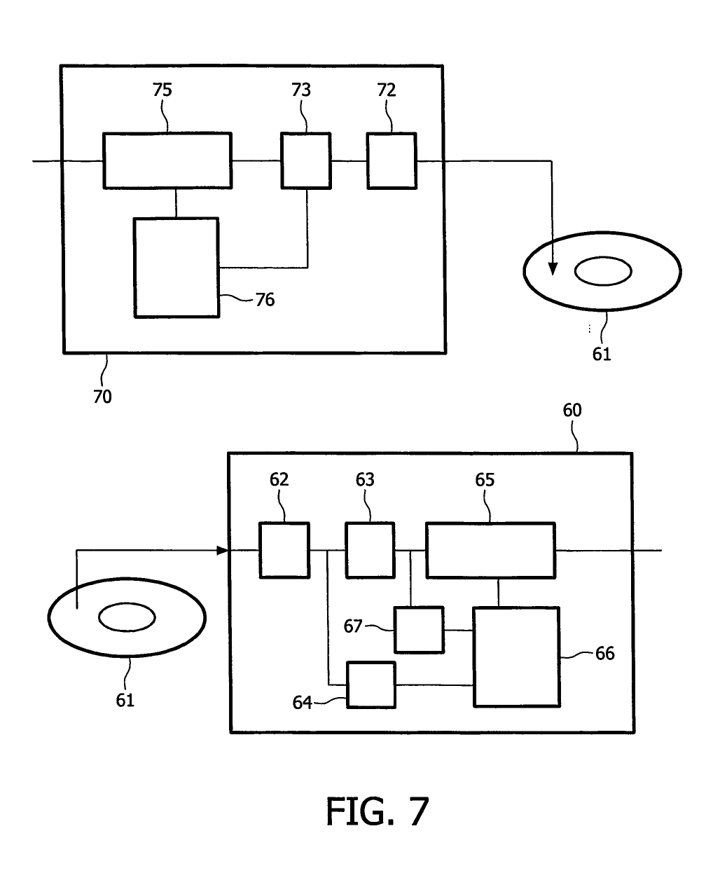

FIG. 7 shows a copy right control system using asymmetry as a watermark.

It should be noted that although the explanation uses a local DC content disturbance, a more statistical approach where the disturbance is spread over more groups of channel bits is also feasible.

FIG. 1 shows asymmetry of channel bits through pit width modulation A group of normal unmodulated channel bits 1 is shown. A high level indicates a reflection of the light by the record carrier, i.e. a land, while a low level indicates a low reflection, i.e. a mark.

Furthermore DC content curves 2,4 are shown. The DC content of the signal is determined by integrating the contribution of the various bits.

The group of normal unmodulated channel bits 1 comprises, for illustration purposes, a series of short alternations of lands and marks. The average contribution to the DC content of the group of channel bits is zero, indicated by a constant value in the corresponding sections of the DC content curve 2. When a longer land 1a leads to a longer duration of the reflection the DC content curve 2 increases to a first level 2a by providing a positive contribution. Subsequently a equally long mark 1b with low reflectivity balances the DC content curve 2 back to zero by providing a negative contribution, thus decreasing the DC content.

When the width of the pit is increased the reflection of the mark is further decreased compared to the normal situation descussed above.

A modulated group of channel bits 3 comprises such a wider pit, represented by a lower reflection of the longer mark 3b. The longer mark 3b provides a more negative contribution than the longer land 3a Consequently, when the DC content curve reaches a first level 4a, equal to the first level 2a of the normal situation, the negative contribution of the longer mark 3a causes the DC content to reach a negative value 4b, instead ofjust returning the DC content curve 4 to zero.

It is a desirable property of signals to be DC content free. The DC content is for that reason kept low and a return to zero of the DC content at the end of groups of channel bits, code words, or groups of code words.

A deviation from zero at the end 4c of a group of channel bits can thus be detected as an abnormal situation, enabling the modulation of the DC content as outlined to represent data or a marker or a watermark.

FIG. 2 shows asymmetry of channel bits through coding

A group of normal unmodulated channel bits 20 is shown. A high level again indicates a reflection of the light by the record carrier, i.e. a land, and a low level again indicates a low reflection, i.e. a mark.

The group of normal unmodulated channel bits 20 comprises, for illustration purposes, a series of short alternations of lands and marks. The average contribution to the DC content of the group of channel bits is zero, indicated by a constant value in the corresponding sections of the DC content curve 21. When a longer land 20a leads to a longer duration of the reflection the DC content curve 21 increases to a first level 21a by providing a positive contribution. Subsequently a equally long mark 20b with low reflectivity balances the DC content curve 21 back to zero 21b by providing a negative contribution, thus decreasing the DC content.

When the coding is used to introduce asymmetry in the group of channel bits a different pattern of bits is produced compared to the normal situation descussed above.

A modulated group of channel bits 22 comprises such a different pattern of bits, represented by a shorter duration mark 22b, when compared to the corresponding longer mark 20b, and a longer duration land 22, when compared to the corresponding shorter land 20c. The shorter mark mark 22b provides a shorter negative contribution than the longer land 20b. Consequently, when the DC content curve 23 reaches a first level 23a, equal to the first level 21a of the normal situation, the negative contribution of the longer mark 22b causes the DC content to decrease to a positive value 23b, instead of just returning the DC content curve 23 to zero.

The longer land 22c subsequently provides a positive contribution to the DC content, resulting in an even more positive end value 23d of the DC content curve 23. It is a desirable property of signals to be DC content free. The DC content is for that reason kept low and a return to zero of the DC content at the end of groups of channel bits, code words, or groups of code words.

A deviation from zero at the end 23d of a group of channel bits can thus be detected as an abnormal situation, enabling the modulation of the DC content as outlined to represent data or a marker or a watermark.

FIG. 3 shows asymmetry of channel bits through transition modulation. The situation when modulating the transitions of the channel bits is similar to the situation discussed in FIG. 2. A modification of the duration of lands and marks disturbes the symmetry, resulting in a non zero DC content at the end of the channel bits. In FIG. 3 this is however not achieved by applying a different coding as in FIG. 2, but is the result of shifting the transitions themselves. In order to be able to retrieve the data the shifting of the transitions is limited because subsequent detection after clock recovery must result in the same data being retrieved compared to the situation where no shifting of the transitions took place.

A group of normal unmodulated channel bits 30 is shown. A high level again indicates a reflection of the light by the record carrier, i.e. a land, and a low level again indicates a low reflection, i.e. a mark.

The group of normal unmodulated channel bits 30 comprises, for illustration purposes, a series of short alternations of lands and marks. The average contribution to the DC content of the group of channel bits is zero, indicated by a constant value in the corresponding sections of the DC content curve 31. When a longer land 30a leads to a longer duration of the reflection the DC content curve 31 increases to a first level 31 b by providing a positive contribution. Subsequently a equally long mark 30b with low reflectivity balances the DC content curve 3 back to zero 31c by providing a negative contribution, thus decreasing the DC content.

When the shifting of the transitions is Lised to introduce asymmetry in the group of channel bits the width of lands and marks are changed. Moving a single transition between a land and a mark does not change the overal 1 length but does change the mark to land ratio.

A modulated group of channel bits 32 comprises such a shifted transition. The extended land 32a provides a positive contribution for a longer time to the DC content resulting in a higher level 33a when compared to the level 31b reached in the normal situation. The subsequent reduced mark 32b provides a negative contribution for a shorter time with the consequence that the DC content 33 no longer returns to zero at the end 33c of the group of channel bits.

It is a desirable property of signals to be DC content free. The DC content is for that reason kept low and a return to zero of the DC content at the end of groups of channel bits, code words, or groups of code words.

A deviation from zero at the end 23d of a group of channel bits can thus be detected as an abnormal situation, enabling the modulation of the DC content as outlined to represent data or a marker or a watermark.

At a specific location on the disc, the a-symmetry of a group of channel-bits is modulated. This measure generates a non-copy-able watermark on the disc. At playback this asymmetry can be recovered from the DC content. If the content and the location of the 10 watermark are not correct, the player refuses to play the disc.

Because virtual all disc copy methods restore the timing of the channel bits, the watermark will disappear after disc cloning. Only full analogue copying without timing restoration will retain the watermark, but this will lead to an increase of timing jitter on the copy. This may make the copy unplayable or at least identifiable as a copy by noting the increased levels of jitter.

FIG. 4 shows the effect of a data slicer on the asymmetry The effect of the slicer is discussed using a group of channel bits that include a lower reflection because of a wider pit.

The group of channel bits 40 comprise a longer land 40a and a longer mark 40b.

The length of the other lands and marks is kept shorter for illustration purposes and does not necessarily reflect an actual existing or possible group of channel bits. They are merely given a different size to set them apart from the land and mark for the dicussion of the invention. 25 This group of channel bits is fed to a conventional data slicer 42 via the input 44, comprising a comparator 42a and a device 42b to establish the proper detection threshold 47.

The device 42b provides the proper threshold 47 to the comparator 42a allowing the comparator 42a to provide an output signal 41 comprising all the timing information of the group of channel bits 40 while removing any amplitude variations such as the lower level of the mark 40b. The duration of the longer land 41a and the longer mark 41b is equal to the long land 40a and long mark 40b of the channel bits.The data slicer provides the output signal 41, representing the channel bits at the output 45 but with the level of the longer mark 41b equal to the level of other marks.

Consequently the information as stored by the modulation in the channel bits is lost in the output signal 41.

In addition to providing the channel bits 40 to the data slicer 42 the channel bits 40 are also provided to the DC content device 43, implemented for instance in the form of an integrator. The DC content device 43 then provides the determined DC content at the output 46. The DC content so provided deviates from the expected DC content. This can easily be determined because the output signal 41 from the data slicer is DC free as illustrated by the DC content curve 48.

A simple comparison between the DC content before and after the data slicer will reveal differences, allowing the detection and demodulation of the record carrier identification information.

It is to be noted that FIG. 4 illustrates the case where a reflection change is used to disturb the DC content In the case of timing variations such as the shifting of transitions or the the use of coding the data slicer does not remove the record carrier identification information but the decoding step, where the replacement code words are replaced by the original code words, or the clock recovery and subsequent sampling will remove the disturbances of the DC content.

In the case of the shifting of the transitions the Phase Locked Loop (PLL) used for clock recovery from the channel bits can provide the demodulation since the shifting of the transitions will show up as an error signal at the phase comparator of the PLL.

At a specific location on the disc, the a-symmetry of a group of channel-bits is modulated. This measure generates a non-copy-able watermark on the disc. At playback this asymmetry can be recovered. If the content and the location of the watermark are not correct, the player refuses to play the disc.

Because virtual all disc copy methods restore the timing of the channel bits, the watermark will disappear after disc cloning. Only full analogue copying without timing restoration will retain the watermark, but this will lead to an increase of timing jitter on the copy. This may make the copy unplayable.

FIG. 5 shows a record carrier with asymmetry.

On a Blue Disc-ROM disc 50 the asymmetry of a group of channel bits 52 is modulated by a group of watermark bits. The location of the group of channel bits 52 with asymmetry and a value indicative to the group of watermark bits are stored at a predefined position, e.g. in the PIC band 51.

The storage of the location of the group of channel bits 52, or groups of channel bits, allows a quick access and retrieval of the group of channel bits 52 while providing better security because when the information is not available because of the use of encryption a complete search of the record carrier is required which is time consuming.

FIG. 6 shows a playback device comprising the asymmetry detector The playback device 60 retrieves data from the record carrier 61.

As explained in FIG. 5 the information about where the the carrier record identification information is located is first retrieved from a special area on the record carrier, in the case of blue disk from the PIC band.

Once the group of channel bits is being retrieved that comprises the asymmetry modulation the block diagram of FIG. 6 becomes valid. The retrieval of the address from the PIC band is within the normal player functionality and need not be discussed. Furthermore the decrypting, if aplied, of the keys and addressing information in the PIC band is achieved with the processor device 66.

To retrieve the record carrier identification information from the record carrier the player 60 comprises a basic engine 62 that retrieves channel bits from an address provided to the basic engine 62 by the processor device 66. The retrieved channel bits are then provided to the data slicer 63 and to the DC content determination device 64. The data slicer 63 effectively removes, as a side effect of the data slicing, the asymmetry from the channel bits before providing the channel bits to the data path for further decoding. In addition a furhter DC content determining device 67 determines the DC content of the channel bits after the data slicer 63 . This further DC content determining device 67 is not required if the DC content of the channel bits is known before hand because of the type constraints placed on the channel bits for instance by the coding. The processor then demodulates based on the output of the DC content determining device 64 whether at the expected location the expected data was modulated using the asymmetry of the channel bits as detected in the DC content of the retrieved channel bits.

The processor can subsequently either block or allow the further decoding of the channel bits in the data path 65 or alternatively indicate to an external device that the material is copyrighted and may not be recorded by the other device.

Once the record carrier is identified known copy right control systems can be used.

Because the data slicer 63 removes the record carrier identification information before providing the channel bits to the processing by the data path 65 the user has no access to the record carrier identification information. The data slicer 63, DC content determining device 64 and 67 and processor 66 can be intergrated into a single device, preventing access by the user. The decryption of the keys, the location of the group of channel bits and the actual content of the group of channel bits are thus well protected from access.

The watermark appears among other things in the low-frequency region of the data spectrum and can be recovered by observing the detection level, or by simple lowpass-or bandpass-filtering the playback signal. Because of the guaranteed 17PP DC-suppression this invention is especially suitable for BD. The watermark detection SNR can be further enhanced by applying a method for minimizing the DC content of the channel bits by coding, in order to limit the low- frequency code spectrum. The latter method is also useful for reducing the amplitude of the asymmetry modulation.

By changing the location and the contents of the watermark from disc to disc, the security of the method is enhanced.

In the signal processing of the Blu Disc drive, keys and the watermark from the CA and PP signal are detected.

The output of the integrator (the detection threshold) will follow the average value asymmetry of the HF-signal. This is a well-known principle and already applied in CD players. It works because of the DC-suppressing property of the channel code.

In this embodiment it is assumed that the bandwidth of the watermark is within the bandwidth of the threshold control loop. Therefore the watermark will not increase the jitter, because the slicer adapts its threshold in order to compensate for the asymmetry modulation.

Above the control bandwidth of the slicer the asymmetry modulation is still present at the output of the threshold detector and the jitter increases.

Prior to playback, the player checks the contents of the watermark at a specific position. The contents and the position of the watermark is encoded into a specific location on the disc, e.g. in the PIC-band (Blu Disc standard).

FIG. 7 shows a copy right control system using asymmetry as a watermark.

The recorder 70 comprises a data path 75 that as part of its function encodes the data into channel bits. The data path then provides the channel bits to the modulator 73.

As described in FIGS. 1, 2 and 3 the modulation can take several forms:
shifting of the transitions of the channel bits
assigning wider pits to certain marks to be recorded to lower reflection
using replacement code words after encoding by replacing code words with code words that do normally not occur in any data stream to control DC content.

Thus the modulator 73 can consequently be implemented as a transition modulator, a code word replacer, or a laser beam power modulator.

The processor 76 receives information from the data path 75 and controls the insertion of the asymmetry modulation in the channel bits. The processor 76 further controls where the channel bits are stored and directs the basic engine 72 to do so.

The channel bits thus processed are provided to the basic engine for recording on the record carrier 61.

It is obvious that the basic engine, in the case of the modulator 73 being a laser beam modulator, must be capable of variying the laser power of the beam it uses to record the channel bits. In the case of the other two modulator embodiments a regular basic engine suffices.

The recorder further also records the location of the channel bits with asymmetry modulation in a special area of the record carrier, such as the PIC band.

The normal configuration of the recorder is suitable for this part of the recording and need not be discussed. The same applies to the encryption of the keys because that is handled by the processor 76 in the regular fashion.

The invention is not limited to professional laser beam recorders, but can also be applied in record-able disc drives like CD-RW, DVD-RW, BD-RE for security reasons.

1. Record carrier comprising a group of channel bits recorded in a track where the group of channel bits comprises record carrier identification information, characterized in that the record carrier identification information is stored in the group of channel bits with an asymmetry modulation.

2. Record carrier as claimed in claim 1,
characterized in that the asymmetry modulation is a pit width modulation

3. Record carrier as claimed in claim 1,
characterized in that the asymmetry modulation is a running digital sum modulation

4. Record carrier as claimed in claim 1,
characterized in that the asymmetry modulation is a channel bit flank position modulation

5. Record carrier as claimed in claim 1, 2, 3 or 4,
characterized in that the channel bits are encoded using a parity preserving code

6. Record carrier as claimed in claim 1, 2, 3, 4 or 5,
characterized in that the record carrier identification information is stored in a predetermined position

7. Record carrier as claimed in claim 6,
characterized in that a pointer to the predetermined position is stored on the record carrier

8. Record carrier as claimed in claim 7,
characterized in that the record carrier comprises a PIC band and that the location of the predetermined position is stored in the PIC band.

9. Method for recording a record identification information on a record carrier comprising a group of channel bits recorded in a track where the group of channel bits comprises record carrier identification information,
comprising the step of:
modulating the record carrier identification information in the group of channel bits with an asymmetry modulation;
storing the group of channel bits with an asymmetry modulation on the record carrier.

10. Method for recording a record carrier identification information as claimed in claim 9,
characterized in that the step of modulating the record carrier identification information in the group of channel bits with an asymmetry modulation comprises the step of modulating a running digital sum of the channel bits.

11. Method for recording a record carrier identification information as claimed in claim 9 or 10,
characterized in that the channel bits are encoded using a parity preserving code

12. Method for recording a record carrier identification information as claimed in claim 9 or 10,
characterized in that the step of storing the group of channel bits with an assymetry modulation on the record carrier comprises the storing of the record carrier identification information in a predetermined position

13. Method for recording a record carrier identification information as claimed in claim 12,
characterized in that the method comprises the step of storing a pointer to the predetermined position on the record carrier

14. Method for recording a record carrier identification information as claimed in claim 13,
characterized in that the record carrier comprises a PIC band and that the pointer of the predetermined position is stored in the PIC band.

15. Method for retrieving a record identification information from a record carrier comprising a group of channel bits recorded in a track where the group of channel bits comprises record carrier identification information,
comprising the step of:
retrieving a group of channel bits with an asymmetry modulation from the record carrier;
demodulating the record carrier identification information from the retrieved group of channel bits with an asymmetry modulation;

16. Method for retrieving a record carrier identification information as claimed in claim 15,
characterized in that the step of demodulating the record carrier identification information from the group of channel bits with an asymmetry modulation comprises the step of demodulating a running digital sum of the channel bits.

17. Method for retrieving a record carrier identification information as claimed in claim 15 or 16,
characterized in that the step of retrieving the group of channel bits with an asymmetry modulation from the record carrier comprises the retrieving of the record carrier identification information from a predetermined position

18. Method for retrieving a record carrier identification information as claimed in claim 17,
characterized in that the method comprises the step of retrieving a pointer to the predetermined position from the record carrier and that the channel bits with an asymmetry modulation are retrieved from the predetermined position indicated by the pointer.

19. Method for retrieving a record carrier identification information as claimed in claim 18,
characterized in that the record carrier comprises a PIC band and that the pointer of the predetermined position is retrieved from the PIC band.

20. Method for copy right control of information stored on a record carrier where the record carrier comprises a record carrier comprising a group of channel bits recorded in a track of the record carrier where the group of channel bits comprises record carrier identification information,
comprising the step of:
retrieving a group of channel bits with an asymmetry modulation from the record carrier;
demodulating the record carrier identification information from the retrieved group of channel bits with an asymmetry modulation;
processing the record carrier identification information to establish a copy right status of the record carrier.

21. Method for retrieving a record carrier identification information as claimed in claim 20,
characterized in that the step of retrieving the group of channel bits with an asymmetry modulation from the record carrier comprises the retrieving of the record carrier identification information from a predetermined position

22. Method for retrieving a record carrier identification information as claimed in claim 21,
characterized in that the method comprises the step of retrieving a pointer to the predetermined position from the record carrier and that the channel bits with an asymmetry modulation are retrieved from the predetermined position indicated by the pointer.

23. Method for retrieving a record carrier identification information as claimed in claim 22,
characterized in that the record carrier comprises a PIC band and that the pointer of the predetermined position is retrieved from the PIC band.

24. Playback device for optical discs comprising an addressing means and a data retrieval means,
characterized in that the playback device further comprises a DC content retrieval means that is arranged for retrieving a record carrier identification information from a record carrier by demodulating an asymmetry of a group of channel bits retrieved from the record carrier from an address indicated by the addressing means.

25. Playback device as claimed in claim 24,
characterized in that the playback device further comprises a copy right control device that is arranged for retrieving a addressing means are arranged to process the record carrier identification information to establish a copy right status of the record carrier the address from a location on the record carrier and where the addressing means is arranged to retrieve a pointer to a location from the record carrier and to indicate the location to the DC content retrieval means.

26. Recording device for record carriers comprising an addressing means and a data recording means,
characterized in that the recording device further comprises a asymminetry modulation device that is arranged for storing a record carrier identification information on a record carrier by modulating an asymmetry of a group of channel bits, where the asymmetry modulation device is coupled to the data recording means which is arranged for recording the group of channel bits provided by the asymmetry modulation device on an location on the record carrier indicated by the addressing means.
